(19) United States
(12) Patent Application Publication
(10) Pub. No.: US 2024/0413387 A1
(43) Pub. Date: Dec. 12, 2024

(54) POWDER OF SOLID MATERIAL PARTICLES OF FORMULA LiaPSbXc (I)

(71) Applicant: SPECIALTY OPERATIONS FRANCE, Lyon (FR)

(72) Inventors: Lauriane D'Alencon, Issy-Les-Moulineaux (FR); Jules Valente, Paris (FR); Thierry Le Mercier, Rosny-sous-Bois (FR)

(73) Assignee: SPECIALTY OPERATIONS FRANCE, Lyon (FR)

(21) Appl. No.: 18/701,469

(22) PCT Filed: Oct. 11, 2022
(86) PCT No.: PCT/EP2022/078257

§ 371 Date: Apr. 15, 2024

(30) Foreign Application Priority Data
Oct. 14, 2021 (EP) 21306437.1

(51) Int. Cl. H01M 10/0562; C01B 25/14; H01M 10/0525; H01M 50/446

(52) U.S. Cl. CPC H01M 10/0562; C01B 25/14; H01M 10/0525; H01M 50/446; C01P 2004/61; C01P 2006/20; C01P 2006/40; C01P 2006/62; H01M 2300/008

(57) ABSTRACT

The present disclosure relates to a powder of solid material particles of formula (I): LiₐPS_{b}X_{c} wherein—X represents at least one halogen element; —a represents a number from 2.0 to 7.0; —b represents a number from 3.0 to 6.0; and —c represents a number from 0 to 3.0, wherein the powder has a d₅₀-value of less than 50 μm, characterised in that its L* value in the L*a*b* color system is less than 60.0. The present disclosure also relates to a process for preparing such powder, as well as to the use of such powder for notably manufacturing solid electrolytes or battery articles.

### CROSS-REFERENCE TO RELATED PATENT APPLICATIONS

The present patent application claims priority from European patent application No. 21306437.1 filed on 14 Oct. 2021, the whole content of this application being herein incorporated.

### TECHNICAL FIELD

The present disclosure relates to a powder of solid material particles of formula (I):

LiₐPS_{b}X_{c} (I)
wherein
   X represents at least one halogen element;
   a represents a number from 2.0 to 7.0;
   b represents a number from 3.0 to 6.0; and
   c represents a number from 0 to 3.0,
wherein the powder has a d₅₀-value of less than 70 μm, characterised in that its L* value in the L*a*b* color system is less than 60.0.

The present disclosure also relates to a process for preparing such powder, as well as to the use of such powder for notably manufacturing solid electrolytes or battery articles.

### BACKGROUND

Lithium ion batteries are widely used as power supplies notably for appliances. In such secondary batteries, an organic solvent is used as an organic liquid electrolyte and lithium ions migrate from one electrode to the other, depending on whether the battery is charging or discharging.

Because the solvent used as an electrolyte is flammable, all-solid-state lithium ion batteries not using organic solvent are very attractive. Such all-solid-state lithium ion batteries are formed by solidifying the whole battery using components, which are all solid, that-is-to-say the cathode, the anode and the electrolyte. Because all the components of the solid-state battery are solid, including the electrolyte, all-solid-state battery have a large electrical resistance and provide a small output current, in comparison to a battery using a liquid electrolyte. This means that there is a need for electrolytes having a high conductivity, as well as an aptitude to maintain this high conductivity over time.

EP 3 026 749 A1 (Mitsui) relates to a sulfide-based solid electrolyte for a lithium ion battery having a cubic crystal structure belonging to a space group F-43m and being represented by Compositional Formula: Li₇₋ₓPS₆₋ₓHaₓ (Ha is Cl or Br), in which x varies from 0.2 to 1.8, and wherein said electrolyte has a value of the lightness L* in the L*a*b* color system is 60.0 or more, preferably 70.0 or more and more preferably 75.0 or more. In the document, the quantity of sulfur in the solid electrolyte is correlated to the L* value of said electrolyte in the L*a*b* color system. More precisely, it is considered that sulfur defects in the solid electrolyte lead to a decrease in the lightness, which should be avoided for performance purpose. In other words, it is considered that the higher the L* value, the better the conductivity.

The inventors have however identified that such products with a high L* value in the L*a*b* color system tend to be very difficult to use when preparing composite layers for separators and catholytes.

An object of the present invention is to provide a powder of solid material particles, which can conveniently be used to prepare composite layers for separators and electrolytes, while preserving a high conductivity. Another object of the present invention is to provide a powder with a resistance to ageing, including aptitude to maintain a high conductivity over time.

### SUMMARY

The present invention relates to a powder of solid material particles formula (I):

LiₐPS_{b}X_{c} (I)
wherein
   X represents at least one halogen element;
   a represents a number from 2.0 to 7.0;
   b represents a number from 3.0 to 6.0; and
   c represents a number from 0 to 3.0,
wherein the powder has a d₅₀-value of less than 70 μm, characterised in that its L* value in the L*a*b* color system is less than 60.0.

In some embodiments, the solid material is according to formula (II):

Li₇₋ₓPS₆₋ₓXₓ (II)
wherein:
   X represents at least one halogen element selected in the group of F, Cl, Br and I or a combination thereof; and
   x represents a positive number from 0.5 to 2.0.

The solid material is preferably Li₆PS₅Cl, Li₄P₂S₆, Li₇PS₆, Li₇P₃S₁₁ or Li₃PS₄.

The present invention also relates to a method for producing the powder of the present invention, comprising the steps of:
a) mixing the starting materials (M) with a carbonated solvent(S) preferably selected among aprotic chain hydrocarbons and aromatic hydrocarbons, using mixing means, preferably mixing beads (made of ceramic preferably), with an energy of at least 7×10⁵ rotations per litre of mixture (M+S), to obtain a paste in a slurry state,
b) drying the paste from step a) to obtain a dried paste,
b′) optionally pressing the dried paste from step b) into pellets, and
c) heating the dried paste, e.g. in the form of pellets, to a temperature comprised between 350° C. and 580° C. for a time period of at least 2 hours, for example at least 4 hours, at least 6 hours, at least 8 hours, at least 10 hours or at least 12 hours.

The present invention also relates to the use of the powder of the present invention to manufacture a solid electrolyte, to a solid electrolyte comprising at least such powder, to an electrochemical device comprising at least such solid electrolyte, to a solid state battery comprising at least such solid electrolyte, and to an electrode or a battery separator comprising at least such powder.

### DISCLOSURE OF THE INVENTION

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

The present invention relates to a powder of solid material particles of formula (I):

LiₐPS_{b}X_{c} (I)
wherein
   X represents at least one halogen element;
   a represents a number from 2.0 to 7.0, for example from 3.0 to 6.0, from 4.0 to 6.0 or from 5.0 to 6.0;
   b represents a number from 3.0 to 5.0, for example from 3.5 to 5.0 or from 3.9 to 5.0; and
   c represents a number from 0 to 3.0, for example from about 0.9 to about 2.9 or from about 1.0 to about 2.5 or even from about 1.0 to about 2.0;
wherein the powder has a d₅₀-value of less than 50 μm, characterised in that its L* value in the L*a*b* color system is less than 60.0.

The inventors surprisingly found that such products with a L* value in the L*a*b* colour system below 60.0 are well-suited, notably, to be used in slurry when preparing composite layers for separator and catholyte layers.

Without being bound to any particular theory, it is believed that powders presenting a L* value below 60.0 present a hydrophobicity well adapted to be mixed with solvents used in the preparation of composite layers. While, according to the inventors' knowledge, it is impossible to characterise the hydrophobicity of such materials due to the lack of identification of a solvent which would not interact with the surface of the material when performing the measurement of e.g. contact angle, the inventors believe that a direct correlation between the L* value of the powder and its hydrophobicity can be made. As such, the hydrophobicity of the material can be assessed indirectly by measuring the L* value in the L*a*b* color system of the material. Contrary to the teaching of the prior art, the powder of the present invention actually presents a L* value in the L*a*b* color system lower than taught in the prior art.

It was also found that the hydrophobicity of the powder positively affects its resistance to ageing over time. Again, without being bound to any particular theory, it is believed that the more hydrophobic the powder, the less water is absorbed (water being identified as having a detrimental effect on sulfide powder, especially over time), the less susceptible to ageing the powder is.

The powder of solid material particles presenting such a low L* value can notably be prepared by wet mechanochemistry with a carbonated solvent of choice combined with a certain amount of energy. The use of such a carbonated solvent during the preparation process of the powder leads to specific carbon species at the surface of the powder.

While it is generally admitted that carbon residues could be detrimental to ionic conductivity (decrease due to grain boundaries) and electronic conductivity (which could increase if carbon content is high), the inventors hereby found that the presence of carbon residues at the surface of the powder in fact provides an improved compromise between the conductivity of the material, its resistance to ageing and its convenience to be used in the preparation of electrolyte composite layers. This makes the material of the present invention well-suited to be used in the preparation of all-solid-state lithium ion batteries.

The powder of the present invention is therefore characterized by a L* value in the L*a*b* color system below 60.0, preferably below 59.0, more preferably below 58.0 and even more preferably below 56.0.

As more precisely described in the examples, the L* value may notably measured with a X-Rite Ci52 spectrophotometer operated by the software OnColor. The apparatus is calibrated thanks to a white standard (L*a*b=95.82−0.60 2.15) and a black trap before any measurement is carried out on a sulfide. A thin layer of powder to be analysed is put in a sample holder with a quartz window to guarantee the stability of the sample during the measurement.

The powder of the present invention may also be characterized by a C-content comprised 0.4 and 2.5 wt. %, for example between 0.5 and 2.0 wt. % or between 0.6 and 1.9 wt. %.

According to formula (I), c may be equal to zero. In this case, the solid material does not comprise any halogen component and the solid material is according to formula (I′):

LiₐPS_{b} (I′)
wherein
   a represents a number from 2.0 to 7.0, for example from 3.0 to 7.0; and
   b represents a number from 3.0 to 5.0, for example from 3.9 to 4.9 or from 4.0 to 4.5.

According to formula (I), c may be from 0.9 to 1.1. In this case, the solid material may be according to formula (I″):

LiₐPS_{b}X_{c′} (I″)
wherein
   c′ represents a number from 0.9 to 1.1, for example equals 1.0.

According to this formula (I″), X is preferably Cl. In this case, formula (I″) is as follows:

LiₐPS_{b}Cl_{c′} (I″)

In some embodiments, the solid material is according to formula (II):

Li₇₋ₓPS₆₋ₓXₓ (II)
wherein:
   X represents at least one halogen element selected in the group of F, Cl, Br and I or a combination thereof; and
   x represents a positive number from 0.5 to 2.0.

According to these embodiments:
x may more particularly vary between 0.8 and 1.8; x may for instance be equal to 1.0 or to 1.5; x may also vary between 0.95 and 1.05 or between 1.45 and 1.55; and/or
X is more particularly Cl, Br or a combination thereof; X may also be more particularly Cl.

In some preferred embodiments, the solid material is Li₆PS₅Cl, Li₄P₂S₆, Li₇PS₆, Li₇P₃S₁₁ or Li₃PS₄, more preferably Li₆PS₅Cl or Li₃PS₄.

Formulas of the solid material described in the present disclosure may be determined according to well-known analytical techniques.

In the present invention, the solid material as characterized by its formula, herein formula (I) or (II), may be the major constituent of the powder. The proportion of this solid material may be at least 60 wt. %, at least 70 wt. %, at least 80 wt. %, at least 90 wt. %, at least 95 wt. % or even at least 98 wt. % or 99 wt. %, based on the total weight of the powder.

The powder may also for example comprise an amorphous phase, and the starting materials used to prepare the powder, for example LiX (X being a halogen, for example Cl), Li₂S, phosphorus sulfide (e.g. P₂S₅), and/or Li₃PO₄.

The powder is also characterized by its size or Particle Size Distribution (PSD). The size of the particles of the powder may be such that it presents:
a d₅₀-value of less than 70 μm, for example less than 65 μm, less than 50 μm or less than 40 μm,
a d₁₀-value higher than 0.05 μm, and/or
a d₉₀-value of less than 100 μm, for example less than 90 μm, less than 80 μm or less than 70 μm,
as measured by laser diffraction in para-xylene.

Preferably, the d₅₀-value is in the range from 2 μm to less than 70 μm, as measured by laser diffraction in para-xylene.

The powder may be constituted of particles, which are aggregated.

The d₅₀-value corresponds to the median of a distribution in number of the diameters of the particles. The measurement of the particle size distribution (PSD), e.g. d₅₀-value, d₁₀-value and d₉₀-value, may be performed with a scanning electronic microscope (SEM) on a number of particles, which is at least 150. Alternatively, it may be performed by laser diffraction in para-xylene.

The particles of the powder may be spheroidal in shape.

The particles of the powder may exhibit a sphericity ratio SR between 0.8 and 1.0, more particularly between 0.85 and 1.0, even more particularly between 0.90 and 1.0. SR may preferably be between 0.90 and 1.0 or between 0.95 and 1.0. The sphericity ratio of a particle is calculated from the measured perimeter P and area A of the projection of the particle using the following equation:

SR=4 πA/P²

For an ideal sphere, SR is 1.0 and it is below 1.0 for spheroidal particles. The SR may be determined by a Dynamic Image Analysis (DIA). An example of appliance that can be used to perform the DIA is the CAMSIZER® P4 of Retsch or the QicPic® of Sympatec. The sphericity ratio may be more particularly measured according to ISO 13322-2 (2006). The DIA generally requires the analysis of a large number of particles to be statistically meaningful (e.g. at least 500 or even at least 1000).

The crystalline phase of the powder (which corresponds to the cubic crystal structure belonging to space group F-4 3 m) may be assessed by X-ray diffractometry (XRD), using Cu radiation source.

The powder may advantageously exhibit an ionic conductivity of at least 1.5 mS/cm, for example at least 1.7 mS/cm, or between 1.9 and 5.0 mS/cm, as measured on pressed (500 MPa) pellets by impedance spectroscopy, for example an ionic conductivity between 2.0 and 4.5 mS/cm.

The measurement of the ionic conductivity was performed on a pressed pellet. Typically, a pressed pellet is manufactured using a uniaxial or isostatic pressure. When uniaxial pressure is applied to form the pellet, a pressure above 100 MPa, preferentially above 300 Mpa, is applied for a duration of at least 30 seconds. The measurement was done under uniaxial pressure typically between 2 MPa and 200 MPa and at room temperature, followed by conversion of the value to 30° C.

The powder of the present invention may also be characterised by its ageing resistance, notably measured by the conductivity change and the weight change over time.

The present invention also relates to a powder obtained by a process involving wet mechanochemistry with a carbonated solvent.

The present invention also relates to such process for producing the powder described above, comprising the steps of:
a) mixing the starting materials (M) with a carbonated solvent(S) preferably selected among aliphatic hydrocarbons (such as heptane) and aromatic hydrocarbons (such as xylenes), using mixing means, preferably mixing beads (for example made of ceramic), with an energy of at least 7×10⁵ rotations per liter of mixture (M+S), to obtain a paste in a slurry state,
b) drying the paste from step a) to obtain a dried paste,
b′) optionally pressing the dried paste from step b) into pellets, and
c) heating the dried paste, e.g. in the form of pellets, to a temperature comprised between 350° C. and 580° C. for a time period of at least 2 hours, for example at least 4 hours, at least 6 hours, at least 8 hours, at least 10 hours or at least 12 hours.

The starting materials (M) are preferably at least lithium sulfide (Li₂S) and phosphorus sulfide.

The carbonated solvent(S) is preferably preferably selected among aliphatic hydrocarbons (for instance hexane, heptane, octane or nonane, preferably heptane) and aromatic hydrocarbons (for instance benzene, toluene, ethylbenzene, xylenes or liquid naphthenes, preferably xylenes). More preferably, the carbonated solvent(S) is selected from the group consisting of xylene, para-xylene, heptane, octane, and mixtures thereof.

In some embodiments, the starting materials of step a) are at least lithium sulfide (Li₂S) and phosphorus sulfide.

In step a), the starting materials (M), e.g. Li₂S, LiCl and P₂S₅, are mixed together. These starting materials are generally in the powder form to obtain an intimate mixture. The amounts of these starting materials are defined to obtain the targeted stoichiometry. A small excess of Li₂S may be used, in particular to compensate for the potential loss of S during the calcination. The excess of Li₂S may for example be up to an additional 10 wt. % versus the targeted stoichiometry.

Step a) is conveniently performed by wet ball-milling the starting materials (M) in the carbonated solvent(S).

The weight ratio “solvent(S)/mixture (M+S)” may be between 0.2 to 3.0, for example between 0.4 to 2.0 or between 0.5 to 1.5.

The duration of the mixing, e.g. milling, may be between 1 to 130 hours, for example preferably between 3 and 70 hours or between 6 and 40 hours.

The step a) of obtaining a paste in a slurry state is conducted with an energy which is of at least 7×10⁵ rotations per liter of mixture (M+S), for example at least 7.1×10⁵ rotations/L, at least 7.5×10⁵ rotations, at least 8.0×10⁵ rotations/L or at least 8.5×10⁵ rotations/L of mixture (M+S).

According to step b), the paste from step a) is dried. Drying may be conveniently performed through the evaporation of the liquid hydrocarbon. The evaporation of the liquid hydrocarbon is preferably performed at a temperature between 100° C. and 150° C., more particularly between 105° C. and 135° C. The evaporation may be performed under vacuum. The duration of the evaporation is generally between 1 and 20 hours, more particularly between 2 and 20 hours or between 3 and 7 hours.

In step c), the mixture of step b) is heated (or calcined), for example in a rotative oven at a temperature between 350° C. and 580° C., for example between 370° C. and 550° C. or between 39° and 530° C. Step c) is preferably performed under an inert atmosphere, for instance under an atmosphere of N₂ or Ar or H₂S. The duration of step c) is between 1 and 12 hours, more particularly between 2 and 10 hours or between 3 and 7 hours. During step c), the crystallinity of the mixture is improved and as a result, the conductivity is improved.

The rotative oven which may be used to calcined the dried paste from step b) or the pellets from step b′) may be spinning at a rotation speed between 0.5 to 10.0 rpm. The size of the granules may be varied through variation of the speed. The higher the rotation speed, the higher the size of the particles. This means also that the higher the rotation speed, the higher the yield of a composition exhibiting the targeted size.

The process may comprise an additional step d) of sieving the granules to select a specific size range. This operation may be performed manually or automatically. In the conditions used in the laboratory, it is advantageously performed manually.

The present invention also relates to various end-use applications of the powder described herein.

The powder of the present invention may be used to manufacture a solid electrolyte.

The present invention also includes:
a solid electrolyte comprising at least the powder described herein,
an electrochemical device comprising at least the solid electrolyte described herein,
a solid state battery comprising at least the solid electrolyte described herein,
an electrode comprising at least:
a metal substrate;
directly adhered onto said metal substrate, at least one layer made of a composition comprising:
(i) the powder of the present invention;
(ii) at least one electro-active compound (EAC);
(iii) optionally at least one lithium ion-conducting material (LiCM) other than the solid material of the invention;
(iv) optionally at least one electro-conductive material (ECM);
(v) optionally a lithium salt (LIS);
(vi) optionally at least one polymeric binding material (P), and
a separator comprising at least:
the powder of the present invention;
optionally at least one polymeric binding material (P);
optionally at least one metal salt, notably a lithium salt;
optionally at least one plasticizer.

Should the disclosure of any patents, patent applications, and publications which are incorporated herein by reference conflict with the description of the present application to the extent that it may render a term unclear, the present description shall take precedence.

### EXAMPLES

The disclosure will be now described in more detail with reference to the following examples, whose purpose is merely illustrative and not intended to limit the scope of the disclosure.

### Materials

### Inventive Material #1

Inventive materials Li₆PS₅Cl are obtained with a process as follows.

In a first step, 15.8 g of LiCl (Sigma-Aldrich, purity>99%); 41.4 g of P₂S₅ (Sigma-Aldrich, purity>99%) and 42.5 g of Li₂S (Sigma-Aldrich) were added into a 500 mL zirconia jar with ZrO₂ balls (10 mm). 100.5 g of para-xylene (Sigma-Aldrich, purity>99%, dry) were then added. The tight jar was rapidly sealed to prevent any solvent evaporation. Wet-ball milling was conducted with a planetary ball-mill. The milling was performed for 21 h at 500 rpm, which corresponds to an energy of approx. 3.8×10⁶ rotations per litre of mixture of the starting materials and the solvent. A slurry paste is obtained.

In a second step, the paste was transferred in a dry alumina crucible and dried under dynamic vacuum at 130° C. in an oven to remove the solvent. After 5 hours of drying, the milling balls were separated from the dried powder through sieving at 4 mm.

In a third step, the dried mixture was charged under argon atmosphere (with less than 10 ppm of water) in an alumina crucible. The crucible was then inserted in a tubular furnace and the product was crystallised at a temperature higher than 400° C. during 12 hours under N₂ flow (20 L/h). The oven was then cooled down before the crucible was collected.

The final product was in the form of a polydisperse powder with some agglomerates of different sizes. The finished product was obtained by dry homogenization.

### Inventive Material #2

In a first step, 19.7 g of LiCl (Sigma-Aldrich, purity>99%); 51.7 g of P₂S₅ (Sigma-Aldrich, purity>99%) and 53.4 g of Li₂S (Sigma-Aldrich) were added into a zirconia jar with ZrO₂ balls (10 mm). 125 g of para-xylene (Sigma-Aldrich, purity>99%, dry) were then added. The tight jar was rapidly sealed to prevent any solvent evaporation. Wet-ball milling was conducted with a planetary ball-mill. The milling was performed for 65 h at 290 rpm. The energy spent to prepare the slurry paste was approx. 6.8×10⁶ rotations per litre of mixture of the starting materials and the solvent.

In a second step, the paste was transferred in a dry alumina crucible and dried under dynamic vacuum at 130° C. in an oven to remove the solvent. After 5 hours of drying, the milling balls were separated from the dried powder through sieving at 4 mm.

In a third step, the dried mixture was charged under argon atmosphere (with less than 10 ppm of water) in an alumina crucible. The crucible was then inserted in a tubular furnace and the product was crystallised at a temperature higher than 400° C. during 12 hours under N₂ flow (20 L/h). The oven was then cooled down before the crucible was collected.

The final product was in the form of a polydisperse powder with some agglomerates of different sizes. The finished product was obtained by dry homogenization.

### Inventive Material #3

In a first step, 16.2 g of LiCl; 52.9 g of P₂S₅, 33.1 g of LiBr and 41.6 g of Li₂S were added into a zirconia jar with ZrO₂ balls (10 mm). 129.4 g of xylene were then added. The tight jar was rapidly sealed to prevent any solvent evaporation. Wet-ball milling was conducted with a planetary ball-mill. The milling was performed for 15 h at 350 rpm. The energy spent to prepare the slurry paste was approx. 1.9×10⁶ rotations per litre of mixture of the starting materials and the solvent.

In a second step, the paste was transferred in a dry round bottom flask and dried under dynamic vacuum at 60° C. in a rotative evaporator to remove the solvent. After 3 hours of drying, the milling balls were separated from the dried powder through sieving at 4 mm.

In a third step, the dried mixture was charged under argon atmosphere (with less than 10 ppm of water) in an alumina crucible. The crucible was then inserted in a tubular furnace and the product was crystallised at 500° C. during 6 hours under N₂ flow (20 L/h). The oven was then cooled down before the crucible was collected.

The final product was in the form of a polydisperse powder with some agglomerates of different sizes. The finished product was obtained by dry homogenization.

### Inventive Material #4

In the first step, 14.7 g of LiCl; 25.7 g of P₂S₅ and 21.2 g of Li₂S were added into a zirconia jar with ZrO₂ balls (10 mm). 123 g of xylene were then added. The tight jar was rapidly sealed to prevent any solvent evaporation. Wet-ball milling was conducted with a planetary ball-mill. The milling was performed for 15 h at 350 rpm. The energy spent to prepare the slurry paste was approx. 1.9×10⁶ rotations per litre of mixture of the starting materials and the solvent.

In a second step, the paste was transferred in a dry round bottom flask and dried under dynamic vacuum at 60° C. in a rotative evaporator to remove the solvent. After 3 hours of drying, the milling balls were separated from the dried powder through sieving at 4 mm.

In a third step, the dried mixture was charged under argon atmosphere (with less than 10 ppm of water) in a dry silicon carbide crucible coated with a papyex sheet. The crucible was then inserted in a tubular furnace and the product is crystallised at 520° C. during 12 hours under N₂ flow (20 L/h). The oven was then cooled down before the crucible was collected.

The final product was in the form of a polydisperse powder with some agglomerates of different sizes. The finished product was obtained by dry homogenization.

### Inventive Material #5

In a first step, 6.2 g of LiCl; 16.3 g of P₂S₅ and 16.8 g of Li₂S were added into a zirconia jar with ZrO₂ balls (10 mm). 91 g of xylene were then added. The tight jar was rapidly sealed to prevent any solvent evaporation. Wet-ball milling was conducted with a planetary ball-mill. The milling was performed for 8 h at 300 rpm. The energy spent to prepare the slurry paste was approx. 8.6×10⁵ rotations per litre of mixture of the starting materials and the solvent.

In a second step, the paste was transferred in a dry round bottom flask and dried under dynamic vacuum at 60° C. in a rotative evaporator to remove the solvent. After 3 hours of drying, the milling balls were separated from the dried powder through sieving at 4 mm.

In a third step, the dried mixture was charged under argon atmosphere (with less than 10 ppm of water) in an alumina crucible. The crucible was then inserted in a tubular furnace and the product was crystallized at 510° C. during 6 hours under N₂ flow (20 L/h). The oven was then cooled down before the crucible was collected.

The final product was in the form of a polydisperse powder with some agglomerates of different sizes. The finished product was obtained by dry homogenization.

### Comparative Material #A

In a first step, 22.7 g of LiCl (Sigma-Aldrich, purity>99%); 59.5 g of P₂S₅ (Sigma-Aldrich, 20 purity>99%) and 61.5 g of Li₂S were added into a zirconia jar with ZrO₂ balls (10 mm). 130 g of para-xylene (Sigma-Aldrich, purity>99%, dry) were then added. The tight jar was rapidly sealed to prevent any solvent evaporation. Wet-ball milling was conducted with a planetary ball-mill. After 7 h of milling at 200 rpm, which corresponds to 5×10⁵ rotations per litre of mixture (the rotation being smaller than 7×10⁵ rotations per litre), a slurry paste was obtained.

Such a material had an L* value in the L*a*b* color system which was above 60.0 and not suitable to be used as a material for a solid state battery with the expected performance properties.

### Comparative Material #B

Standard material Li₆PS₅Cl was obtained with the following process.

In a first step, 0.631 g of LiCl (purity>99%); 1.655 g of P₂S₅ (purity>99%) and 1.713 g of Li₂S (purity>99%) are added into a 45 mL zirconia jar with 5 mm ZrO₂ balls. Ball milling was conducted with a planetary ball-mill. After 2 hours of milling at 500 rpm, a mixed powder was obtained.

In a second step, the powder was homogenised in a mortar inside an Ar filled glovebox (<1 ppm H₂O, <1 ppm O2) and then pelletized under 500 MPa to make 6 mm diameter pellets with a mass ranging from 300 to 500 mg. These pellets were sealed under vacuum in carbon covered quartz tubes. The products were crystallised at 550° C. for 7 h with a heating and cooling ramp of 0.5° C./min.

The final product was in the form of densified pellets. The finished product was obtained by dry homogenization with a mortar in the Ar filled glovebox.

### Test Methods

### L* Value in the L*a*b* Color System

The L value is measured with a X-Rite Ci52 spectrophotometer operated by the software OnColor. The apparatus is calibrated with to a white standard (L*a*b=95.82-0.60 2.15) and a black trap before any measurement is carried out on a sulfide. A thin layer of powder to be analysed is put in a sample holder with a quartz window to guarantee the stability of the sample during the measurement.

### PSD

The PSD of the dispersion is measured by laser diffraction using para-xylene in a Malvern Mastersizer 3000.

### Conductivity & Electrochemical Impedance Spectroscopy (EIS)

Before the impedance spectroscopy measurements, powder samples were cold-pressed at 500 MPa in an Ar filled glovebox. The conductivity was acquired on pellets done using a uniaxial press operated at 500 MPa.

Pelletizing was done using a lab scale uniaxial press in glovebox filled with moisture free Argon atmosphere. Two carbon paper foils (Papyex soft graphite N998 Ref: 496300120050000, 0.2 mm thick from Mersen) are used as current collector. Pellets with their carbon electrodes attached are then loaded into air-tight sample holders and a pressure of 40 MPa is applied on the sample holder for the measurement. The impedance spectra are acquired on a Biologic VMP3 device. The samples are placed in a Binder thermostatic chamber to perform the impedance measurements at different temperatures. Each spectrum is acquired after 2 hours of stabilization at the target temperature. The temperature range goes from −20° C. to 60° C. by steps of 10° C. Impedance spectroscopy is acquired in PEIS mode with an amplitude of 20 mV and a range of frequencies from 1 MHz to 1 kHz (25 points per decade and a mean of 50 measurements per frequency point).

### Results

### PSD Results

### Inventive Material #1

d₁₀-value=27 μm
d₅₀-value=61 μm
d₉₀-value=107 μm

### Inventive Material #2

d₁₀-value=4 μm
d₅₀-value=16 μm
d₉₀-value=43 μm

### Inventive Material #3

d₁₀-value=7 μm
d₅₀-value=26 μm
d₉₀-value=62 μm

### Inventive Material #4

d₁₀-value=8 μm
d₅₀-value=22 μm
d₉₀-value=50 μm

### Inventive Material #5

d₁₀-value=3 μm
d₅₀-value=10 μm
d₉₀-value=48 μm

### Comparative Material #B

d₁₀-value=7 μm
d₅₀-value=27 μm
d₉₀-value=103 μm

| | | | | | | Comparative |
|---|---|---|---|---|---|---|
| | Inventive material | | | | | material |
| | #1 | #2 | #3 | #4 | #5 | #B |
| L* value | 46.9 | 52.5 | 58.0 | 50.0 | 54.3 | 71.0 |
| σi | 1.45 | 2.20 | 9.40 | 7.00 | 7.00 | 3.50 |
| (mS/cm) | | | | | | |
| at 30° C. | | | | | | |
| C-content | 1.6% | 1.1% | 0.21% | 0.37% | 2.8% | Not |
| | | | | | | measured |

1. A powder of solid material particles of formula (I):
LiₐPS_{b}X_{c} (I)
wherein
X represents at least one halogen element;
a represents a number from 2.0 to 7.0;
b represents a number from 3.0 to 6.0; and
c represents a number from 0 to 3.0,
wherein the powder has a d₅₀-value in the range from 2 μm to less than 70 μm, as determined by laser diffraction using para-xylene, characterized in that its L* value in the L*a*b* color system is less than 60.0.

2. The powder of claim 1, wherein the solid material is according to formula (II):
Li₇₋ₓPS₆₋ₓXₓ (II)
wherein:
X represents at least one halogen element selected in the group of F, Cl, Br and I or a combination thereof; and
x represents a positive number from 0.5 to 2.0.

3. The powder of claim 1, wherein the solid material is Li₆PS₅Cl, Li₄P₂S₆, Li₇PS₆, Li₇P₃S₁₁ or Li₃PS₄.

4. The powder of claim 1, presenting:
a d₅₀-value of less than 50 μm,
a d₁₀-value higher than 0.05 μm, and/or
a d₉₀-value of less than 100 μm,
as measured by laser diffraction in para-xylene.

5. The powder of claim 1, presenting an ionic conductivity of at least 1.5 mS/cm, as measured on pressed (500 MPa) pellets by impedance spectroscopy.

6. The powder of claim 1, wherein the powder is obtained by a process involving wet mechanochemistry with a carbonated solvent.

7. The powder of claim 6, wherein the process comprises the steps of:
a) mixing the starting materials (M) with a carbonated solvent(S) using mixing means with an energy of at least 7×10⁵ rotations per litre of mixture (M+S), to obtain a paste in a slurry state,
b) drying the paste from step a) to obtain a dried paste,
b′) optionally pressing the dried paste from step b) into pellets; and
c) heating the dried paste, e.g. in the form of pellets, to a temperature between 350° C. and 580° C. for a time period of at least 2 hours.

8. The powder of claim 7, wherein the starting materials (M) are at least lithium sulfide (Li₂S) and phosphorus sulfide.

9. The powder of any one of claim 6, wherein the solvent is selected from the group consisting of p-xylene, heptane, octane, and mixture thereof.

10. A process for manufacturing a powder of solid material particles of formula (I):
LiₐPS_{b}X_{c} (I)
wherein
X represents at least one halogen element;
a represents a number from 2.0 to 7.0;
b represents a number from 3.5 to 6.0; and
c represents a number from 0 to 3.0,
wherein the powder has a d₅₀-value of less than 50 μm, characterised in that its L* value in the L*a*b* color system is less than 60.0, the process comprising the steps of:
a) mixing the starting materials (M) with a carbonated solvent(S) using mixing means with an energy of at least 7.0×10⁵ rotations per litre of mixture (M+S), to obtain a paste in a slurry state,
b) drying the paste from step a) to obtain a dried paste,
b′) optionally pressing the dried paste from step b) into pellets; and
c) heating the dried paste, e.g. in the form of pellets, to a temperature between 350° C. and 580° C. for a time period of at least 2 hours.

11. (canceled)

12. A solid electrolyte comprising at least the powder of claim 1.

13. A solid state battery comprising at least the solid electrolyte of claim 12.

14. An electrode comprising at least:
a metal substrate;
directly adhered onto said metal substrate, at least one layer made of a composition comprising:
(i) the powder of claim 1;
(ii) at least one electro-active compound (EAC);
(iii) optionally at least one lithium ion-conducting material (LiCM) other than the solid material of the invention;
(iv) optionally at least one electro-conductive material (ECM);
(v) optionally a lithium salt (LIS); and
(vi) optionally at least one polymeric binding material (P).

15. A separator comprising at least:
the powder of claim 1;
optionally at least one polymeric binding material (P);
optionally at least one metal salt, notably a lithium salt; and
optionally at least one plasticizer.
